(19) United States
(12) Patent Application Publication
(10) Pub. No.: US 2026/0359882 A1
(43) Pub. Date: Nov. 12, 2026

(54) Process For Matchmaking Sellers And Influencer-affiliates in an Online Sales Broadcast

(71) Applicant: Jatango, LLC, Valley View, OH (US)

(72) Inventor: Phil Steven LONDRICO, Valley View, OH (US)

(21) Appl. No.: 19/201,285

(22) Filed: May 7, 2025

(51) Int. Cl. G06Q 30/0601; H04N 21/2187; H04N 21/254

(52) U.S. Cl. CPC G06Q 30/0641; H04N 21/2187; H04N 21/2542

(57) ABSTRACT

A computer-implemented method and computer program for carrying out a live e-commerce video stream are provided. The method and program are carried out by executing steps including providing one or more store accounts having at least one product for sale, and one or more seller accounts having a plurality of social media followers. Users interact with the program through a graphical user interface that allows for creating affiliations between stores and sellers, managing product collections, and executing live-streaming ecommerce events across multiple social media platforms simultaneously. Customers may or may not have an account on the platform provided herein, and may engage with the platform through their preferred social media channels, including making purchases.

### I. BACKGROUND OF THE INVENTION

### A. Field of Invention

The invention relates to the field of live-streaming e-commerce events.

### B. Description of the Related Art

The rise of online retail platforms, such as Amazon, has significantly shifted consumer purchasing behavior, leading to a decline in foot traffic for traditional brick-and-mortar stores. This trend was further exacerbated by the COVID-19 pandemic, which accelerated the transition to online shopping as consumers sought to avoid in-person retail environments. As a result, many physical retail stores, including small boutiques and independent shops, have experienced substantial losses, with some forced to shut down entirely.

A critical challenge faced by these stores is their limited or nonexistent online presence. Many lack a dedicated e-commerce platform, and those that do often struggle to generate sufficient web traffic to drive meaningful sales. This lack of digital engagement leaves retailers with excess inventory that remains unsold, leading to financial strain and operational inefficiencies. Without an effective solution to bridge the gap between physical retail and online consumer engagement, these businesses continue to face declining revenue and an inability to compete in the evolving retail landscape.

The rise of social media platforms such as Facebook, YouTube, TikTok, and others has enabled everyday individuals to become online influencers, creating highly engaged communities and significantly impacting consumer purchasing behavior. Live commerce, where influencers showcase products during live-streamed events, has emerged as a powerful sales channel. However, despite its growth, influencers face critical challenges in sourcing and selling products effectively.

A primary issue is that influencers often struggle to find suitable products to feature during their live shows. Even when they identify desirable products, they must purchase inventory upfront, manage online orders in real time, and handle product fulfillment, including packaging and shipping. These operational burdens make the process complex, time-consuming, and inefficient, discouraging many influencers from leveraging live selling as a scalable revenue stream.

As a result, there is a disconnect between influencers with large, engaged audiences and stores with excess inventory looking to sell products. Without an efficient system to bridge this gap, influencers remain underutilized as sales drivers, and businesses miss out on valuable promotional opportunities. Embodiments of the invention may resolve one or more shortcomings of the prior art.

### II. SUMMARY OF THE INVENTION

Some embodiments of the present invention provide a novel system and method that seamlessly connects influencers with stores, enabling them to showcase and sell products without the need to purchase, store, or fulfill inventory—allowing influencers to focus on engaging their audience while driving sales through live commerce.

Embodiments may relate to a system and/or method that facilitates a seamless connection between influencers with engaged audiences and stores seeking to promote and sell products. Such systems may be implemented via a website and/or mobile application (e.g., Jatango.com), enabling influencers and stores to establish partnerships through a predefined commission structure.

A digital platform is provided for enabling influencers and stores to establish a commercial partnership. The partnership is initiated through the platform and confirmed via electronic communication, such as email or other notification methods. As part of this process, the influencer and the store agree on a predetermined commission rate for sales generated through the platform.

Upon confirmation, the influencer may select products they wish to showcase, allowing for a curated and personalized promotional experience. The system facilitates dual live commerce events in which both the influencer and store participate in a synchronized live-streaming session. This session occurs on the platform and can be simultaneously broadcast to third-party social media sites by the store and/or the seller.

The dual live format comprises side-by-side video streams, wherein the influencer and a representative from the store interact in real-time. During the live session, the store's representative may physically present the selected products while the influencer discusses their features and benefits with their audience. Therefore, the influencer does not need to have possession of any merchandise to carry out the live-stream event.

According to embodiments of the invention, the platform tracks and records sales generated through the live event, and automatically calculates and processes commission payments. The influencer's commission is deducted from the store's sales and is distributed via the platform's integrated payment system.

This invention provides an efficient, scalable, and automated method for enabling direct collaboration between influencers and stores, enhancing the reach and effectiveness of live commerce transactions.

As used herein, the term seller means any user with ownership, or in possession, of products for sale.

As used herein, the term seller is interchangeable with host, influencer, or social media influencer.

As used herein the term store includes retail stores and sellers. Stores include “wholesalers”, which are also referred to as wholesale-stores. Wholesalers are a kind of store that offers products for bulk purchase to other store account holders rather than mere buyer-users.

The acronym GUI is shorthand for graphical user interface, which has its conventional meaning in the computer engineering arts.

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

Terms of degree, terms of approximation, and/or subjective terms may be used herein to describe certain features or elements of the invention. In each case sufficient disclosure is provided to inform the person having ordinary skill in the art in accordance with the written description requirement and the definiteness requirement of 35 U.S.C. 112.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof, wherein like reference numerals indicate like structure, and wherein:

FIG. 1A is a schematic diagram illustrating a process for forming an affiliate relationship between a store and a seller;

FIG. 1B is a continuation of the process outlined in FIG. 1A;

FIG. 2A is a schematic diagram illustrating a process for a seller-user starting a live streaming ecommerce event according to an embodiment of the invention;

FIG. 2B is a schematic diagram illustrating a process for a store-user starting a live streaming ecommerce event according to an embodiment of the invention;

FIG. 2C is a schematic diagram illustrating an abbreviated process for a first user admitting a second user to a live streaming ecommerce event according to an embodiment of the invention;

FIG. 3 is a drawing of a connection request table;

FIG. 4 is a schematic diagram of an affiliate relationship according to an embodiment of the invention;

FIG. 5A is a process of a store affiliating with a seller and executing a live streaming ecommerce event according to an embodiment;

FIG. 5B is a continuation of the process of FIG. 5A;

FIG. 5C is a continuation of the process of FIG. 5B;

FIG. 6A is a process of a seller affiliating with a store and executing a live streaming ecommerce event according to an embodiment;

FIG. 6B is a continuation of FIG. 6A;

FIG. 6C is a continuation of FIG. 6B;

FIG. 7 is a process of reserving inventory;

FIG. 8 is a process of releasing an inventory hold after an expiry period runs;

FIG. 9 is a process of converting an inventory hold to a permanent reduction of inventory; and

FIG. 10 is a process of updating inventory to account for a permanent reduction.

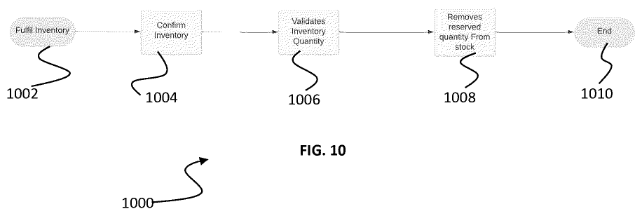

### IV. DETAILED DESCRIPTION OF THE INVENTION

Embodiments of the invention include methods, software, and computer systems for forming affiliate relationships between stores in possession or control of goods, and online influencer personalities capable of selling those products to their followers. Processes are provided for constructing store-user and seller-user accounts from predetermined account types. Predetermined account types include store and seller account types, and may optionally include a third user type referred to herein as a buyer-user account type, and optionally a fourth referred to herein as a wholesaler account type. Embodiments may provide for a single account type with selectable features. For example, all users may create new accounts from the same basic type, but may be afforded different features based on selections made by the user. Certain features such as uploading product catalogs may be reserved for users that identify themselves as stores. Buyer-users may have very limited access to platform features, only to the extent necessary to stream product videos, browse and search for products, and make purchases, but may not have access to scheduling live streaming events or uploading catalogs.

According to some embodiments, persons wishing to make purchases on the platform embodiment must have a user account, namely a buyer-user account. In other embodiments, such persons may interact with the platform as a guest until a purchasing transaction is contemplated e.g., buy placing or attempting to place a product in an electronic shopping cart, at which time the buyer-user is required to make an account before a transaction can commence. Regarding embodiments where buyer-users need not have a user account, a buyer-user may engage with the platform embodiment as a guest through an account on a third-party social media platform.

In regard to the wholesaler account type, this account type provides for selling products in bulk to users of seller accounts rather than users that are limited to buyer-user functionality.

Certain functions of the user account types are shared. In other words, user account types are not necessarily mutually exclusive. For instance, while the description herein focuses on use cases where the seller is not also a store, platform embodiments may provide stores with GUI functionality to conduct live streaming ecommerce events just as a seller would, and may even allow one store to serve as a seller promoting products for another store. Similarly, platform embodiments may provide store and/or seller user types with GUI functionality to make purchases and/or to view live streaming ecommerce events as an audience member.

Graphical user interface (GUI) controls are provided in unique forms, configurations, arrangements, and functionality adapted to change the state of an ecommerce platform such that the affiliation between store and seller accounts is formed and, as a result, the seller and store accounts are enabled to interact with each other according to a seller-store affiliation relationship as described herein. Live-streaming ecommerce events are conducted in accordance with the affiliation. Furthermore, such live-streaming ecommerce events according to embodiments of the invention comprise at least one, and often two or more, video streams. In a first video stream, for example, a seller engages in promotional sales techniques similar to an infomercial; however, unlike a typical infomercial, the seller need not have possession of a sample of the product that he or she is promoting, or even video footage of the product. Instead, in a second live video stream, the product may be held, displayed, and/or demonstrated by a user of the store account. The store would have possession or control of inventory for fulfilling sales orders.

Embodiments also include means for purchasing products promoted in the livestream ecommerce event. Means for purchasing include GUI controls such as, without limitation, a buy button and interactive images of a product overlaying or embedded in a livestream. In the case of interactive images, clicking a product image may transport the user to a details screen showing, for instance, additional product images, a list of product features or product specs, warranty information, shipping information, and so on. According to embodiments using a details screen in this way, a means for purchasing products would be accessible from the details screen. For example, the details screen may contain such means as e.g., a buy button, or a buyer-user may navigate to such means from the details page. Another example of a means for purchasing is an interactive product image that functions like a buy button. For instance, clicking an interactive product image may transport the buyer-user directly to a shopping cart for checkout.

Live stream ecommerce events further comprise a multiplatform chat control. In general, such a control allows buyer-users to communicate simultaneously with the seller, the store, and other members of the audience from third-party chat platforms, such as those found in many social media platforms like Facebook, X, Instagram, YouTube, TikTok and so on. Multiplatform chat controls according to embodiments of the invention may include visual indicia identifying the platform from which a buyer-user is engaging with the live stream event.

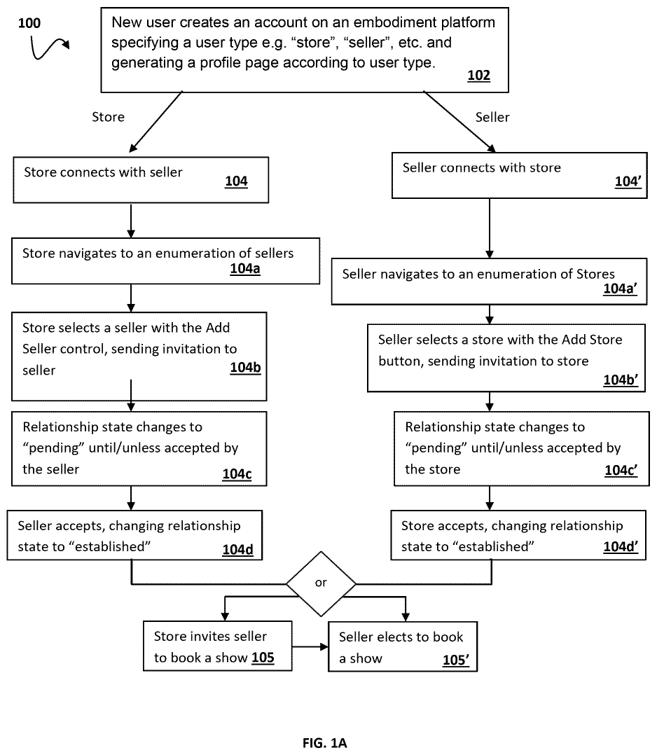

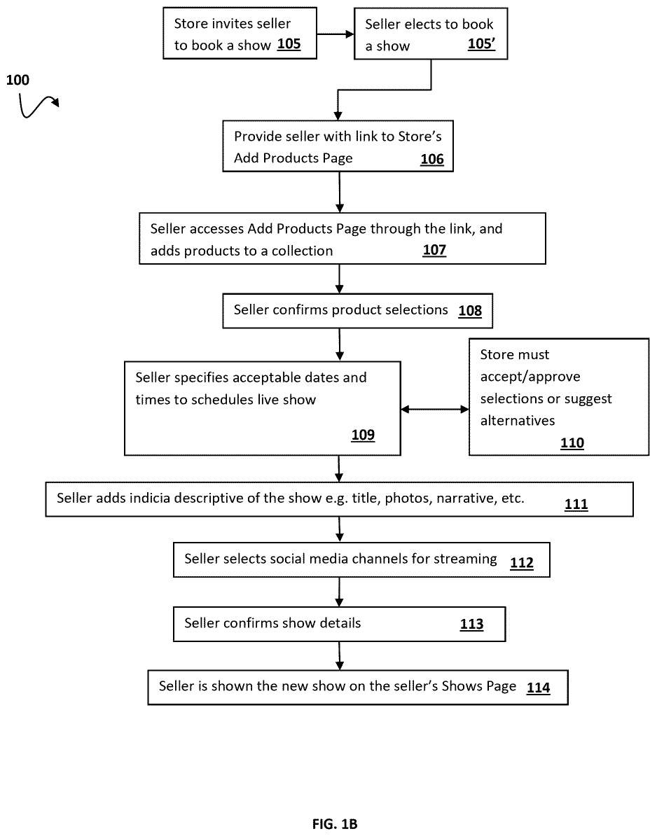

Referring now to the drawings wherein the showings are for purposes of illustrating embodiments of the invention only and not for purposes of limiting the same, FIG. 1A is a schematic diagram illustrating a computer implemented process 100 of forming an affiliation between a store account and a seller account using a GUI as will be described in more detail. In step 102 a new user creates an account on the platform, specifying a user account type, sometimes referred to herein simply as user types. User account types include (i) store accounts, sometimes referred to herein as seller accounts, and (ii) seller accounts, sometimes referred to herein as influencer accounts. Embodiments may optionally include (iii) wholesaler account types, and (iv) buyer account types or other account types as well; however, this is not a requirement of the invention. In this way one or more store accounts, seller accounts, wholesaler accounts, and/or buyer accounts may be provided by an embodiment. Furthermore, store accounts may have one or more products listed for sale, and seller accounts may have a plurality of social media followers on third-party platforms.

If the new user elects to create a store account, the process branches to step 104 where the store connects with a seller. A parallel process step for sellers connecting with stores branches to step 104′. Continuing with step 104, the store connects with a seller. This step proceeds in several sub-steps, 104a through 104d, disclosing the technical details of how a connection is made. First the user of a store account navigates to a GUI-rendered selectable enumeration of sellers indicating seller accounts on the platform (104a). Various GUI controls may be provided to enable such navigation, wherein the quality of being selectable means that the elements of the enumeration are interactive. Alternatively or additionally, the store user may interact with a search feature of an embodiment to search for a particular seller. Interacting with an element of a selectable enumeration may cause the software to shift focus to the element so that it is ready to receive user input, or it may cause the software to execute a predetermined instruction such as an instruction to send a message to the seller represented by the element, or to open a screen having more information about the seller.

For instance, and without limitation, a tab control may be provided, which displays the enumeration of sellers, and may be titled e.g., “sellers”. The sellers tab includes an interactive listing of sellers, which becomes active when the sellers tab is selected. The person of ordinary skill will recognize that the listing of sellers is the enumeration, and each seller in the list is an element of the enumeration. The list of sellers can take various forms including a simple list of names. Alternatively, each element of the seller list can be an information-dense user-friendly tile containing key information allowing the user of a store account to make informed comparative decisions at a glance concerning which seller to connect with. Moreover, the tile may be linked to the sellers'profiles, which may contain additional information that may be helpful to inform a store's decision. The profile may include an Add Seller control as described in more detail below. Further, the same or similar Add Seller control may be included in both the tile and the profile.

When such a seller is identified, the user of the store account selects the seller (104b) by actuating an Add Seller control, such as but not limited to a button, a radio button, a hyperlink, or a plus icon. Actuating the Add Seller control causes a message to be sent to the selected seller inviting a user of the seller account to connect the seller account to the store account. In this context, the term “connect” means to form an affiliation business relationship defined by a relational database table and a set of permissions. For example, and without limitation, actuating the Add Seller control in this step (104b) communicates one or more instructions to the platform to convert the relationship from unrelated to pending. In one embodiment, in response to actuating the Add Seller control, a pub/sub messaging system communicates instructions to the platform that causes a relational database update reflecting that the invitation has been made and is awaiting acceptance. The pub/sub messaging system may at the same time trigger a secondary human-readable message to the invited seller according to any messaging protocol capable of communicating hyperlinks e.g., email or SMS text messaging. The person of ordinary skill will recognize that the term secondary message is not an indication of chronological or hierarchical order, rather, secondary merely indicates the order in which the message is presented in the present disclosure. After actuating the Add Seller control, and before the seller accepts the invitation, the visual elements of the Add seller control change to indicate a pending status 104c. For example, if the Add Seller control is represented as a plus sign before actuation, it may be represented by displaying the text “pending” after actuation.

The human-readable invitation message sent to the seller account includes an interactive means for accepting the invitation. For example, the interactive means for accepting the invitation may be a hyperlink or GUI control. Actuating a hyperlink in this step would cause one or more instructions to be communicated to the platform to convert the relationship from pending to established. For instance, in one embodiment, in response to actuating the hyperlink, a pub/sub messaging system communicates instructions to the platform that causes a relational database update reflecting acceptance of the invitation. The person of ordinary skill will recognize that the same function can be performed by other means such as a GUI control embedded in the invitation message, or by a return message that simultaneously responds to the store account user's invitation in a human readable form, and communicates computer readable instructions to the platform to change the relationship from pending to established. An interactive means for accepting the invitation can be a clickable control such as an “accept” button, a hyperlink, a check box, or other control the skilled artisan may select as a matter of design choice. When the means for accepting is actuated, an affiliate relationship is formed between the store and the seller 104d.

Preferably, an invitation from a store to a seller, or from a seller to a store, further includes information about the invitor sufficient to enable the invitee to make an informed decision about forming an affiliate relationship with the invitor. In some embodiments, where the invitor is a store, the invitation can include information such as, without limitation, the name of the store, its location, the kind of products that the store sells, amount and kind of inventory, the commission rate it offers, and/or a specific enumeration of products available to the seller to sell. Alternatively, where the invitor is a seller, the invitation can include information such as the name of the seller, the number of followers of the seller, the kinds of products the seller has represented, and so on.

Although it has been disclosed herein that a commission rate may be named in a store's invitation to a seller and/or on a store's profile, suggesting that the seller can either accept or reject the commission, embodiments also provide for negotiating a commission. For instance, and without limitation, a seller may request a commission different from the one in a store's profile or in a store's invitation to the seller. Features of the invention include providing a means for negotiating the terms of an affiliate relationship, including commission rate. In this sense, an invitation by either the store or seller is merely an opening offer that can be accepted, rejected or countered. Moreover, embodiments provide for negotiating and renegotiating a commission and/or any other term of an affiliate relationship globally at the store-seller relationship level, at a show level, and even at a product level.

In other embodiments, the interactive means for accepting the invitation may have two components, where actuating a first interactive component contained within the message transports the seller-user to a page or screen containing the foregoing information about the seller, and further containing a second interactive component of the means for accepting. The second component for accepting the invitation may be an interactive control, the actuation of which indicates the seller-user's assent to the affiliate relationship 104d. Similar to the embodiment described in the preceding two paragraphs, the interactive second component for accepting the invitation may be a hyperlink where actuating the hyperlink communicates one or more instructions to the platform to convert the relationship from pending to established. Also similar to the previous embodiment, the person of ordinary skill will recognize that the same function can be performed by other means such as a GUI control embedded in the invitation message, or by a return message that simultaneously responds to the store account user's invitation in a human readable form, and communicates computer readable instructions to the platform to change the relationship from pending to established. The second interactive component of the means for accepting the invitation can be a clickable control such as an “accept” button, a hyperlink, a check box, or other control the skilled artisan may select as a matter of design choice.

Turning back to the parallel process for a seller connecting with a store, this step also proceeds in several sub-steps 104a′ through 104d′ detailing how a connection is made. First the seller navigates to an enumeration of stores indicating store accounts (104a′). Any of various GUI controls may be provided to enable such navigation. For instance, and without limitation, a tab control may be provided and may be titled e.g., “stores”. The stores tab includes an interactive listing of stores. The list of stores can take various forms including a simple list of names. Alternatively, each element of the store list can be an information-dense user-friendly tile containing key information allowing the user of a seller account to make informed comparative decisions concerning which store to connect with. When such a store is identified, the user of the seller account selects the store (104b′) by actuating an Add Store control, such as a button, a radio button, or a plus icon. Moreover, the tile may be linked to the stores'profiles, which may contain additional information that may be helpful to inform a seller's decision. The profile may include an Add Store control as described in more detail below. Further, the same or similar Add Store control may be included in both the tile and the profile.

Actuating the Add Store control causes a message to be sent to the selected store inviting a user of the store account to connect the store account to the seller account. In this context, the term “connect” means to form an affiliation business relationship, similar to step 104. Another message is sent simultaneously to the platform through a pub/sub system, instructing a real time database to add a relational database table reflecting the pending relationship. The invitation message may be sent according to any messaging protocol capable of communicating hyperlinks e.g., email and SMS text messaging. After actuating the Add Store control, and before the store accepts the invitation, the visual elements of the Add Store control change to indicate a pending status 104c′. For example, if the Add Store control is represented as a plus sign before actuation, it may be represented by displaying the text “pending” after actuation.

The human-readable invitation sent to the store includes an interactive means for accepting the invitation. For example, the interactive means for accepting the invitation may be a hyperlink which may be communicated by any suitable messaging protocol including SMS and email. Actuating a hyperlink in this step would communicate one or more computer-readable instructions to the platform to convert the relationship from pending to established by updating the relational database record. The person of ordinary skill will recognize that the same function can be performed by other means such as a GUI control embedded in the invitation message, or by a return message that simultaneously responds to the seller account user's invitation in a human-readable form and communicates computer-readable instructions to the platform to change the relationship from pending to established. An interactive means for accepting the invitation can be a clickable control such as an “accept” button, a hyperlink, a check box, or other control the skilled artisan may select as a matter of design choice. When the means for accepting is actuated, an affiliate relationship is formed between the seller and the store 104d′.

Preferably, an invitation further includes information about the seller sufficient to enable the store to make an informed decision about forming an affiliate relationship with the seller. In some embodiments, the invitation can include information such as, without limitation, the name of the seller, location, the kind of products that the seller has sold, the amount of product sold, and/or the dollar value of products sold.

In other embodiments, the interactive means for accepting the invitation may have two human-readable components, where actuating a first interactive component contained within the message transports the store-user to a page or screen containing information about the seller-invitor and further containing a second interactive component of the means for accepting. The second component of the means for accepting the invitation may be an interactive control, the actuation of which indicates the store-user's assent to the affiliate relationship. The interactive second component for accepting the invitation may be a hyperlink. Actuating the hyperlink communicates one or more instructions to the platform to convert the relationship from pending to established by updating the relational database table and permissions defining the store-seller affiliation relationship. The person of ordinary skill will recognize that the same function can be performed by other means such as a GUI control embedded in the invitation message, or by a return message that simultaneously responds to the store account user's invitation in a human-readable form, and communicates computer-readable instructions to the platform to change the relationship from pending to established. The second interactive component of the means for accepting the invitation can be a clickable control such as an “accept” button, a hyperlink, a check box, or other control the skilled artisan may select as a matter of design choice.

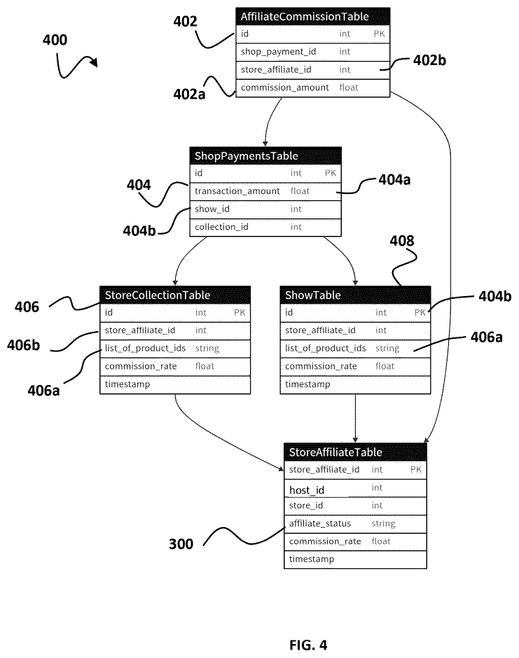

With continuing reference to FIG. 1A, the two parallel branches of the process terminating in steps 104d and 104d′ reconverge. Once the relationship between seller and store is established in steps 104d or 104d′, a live show can be booked at any time. With reference to FIG. 1A, a show is either booked by the seller without prompting 105′ or the store can invite the seller to book a show 105 followed by step 105′. In other words, either step 104d or step 104d′ can proceed directly to 105′ or it can pass through 105 first. In either case, the seller's timeslot options for booking a live show and the products that it may select for representation during the show are limited to those which the store has already indicated as acceptable. The store's indication of acceptability is defined by a set of predetermined permissions that are set in response to updating the relational database to reflect that the seller-store affiliation relationship is established. The store may designate its entire catalog as acceptable, or it may designate a selected portion thereof. Additionally, the seller may defer to the store to select products for the seller to represent by selecting a Store's Choice control, which turns over product selection to the store. A suitable control for the Store's Choice feature includes GUI toggle switches, which are sometimes referred to as toggle buttons. Suitable controls also include checkboxes, sliders, dropdown menus, buttons, or modal dialogues. If the Store's Choice control is actuated, the store will compile a list of products (list_of_product_ids) comprising a variable recorded in a Store Collection relational database table (see element 406a of FIG. 4). This feature enhances convenience and control for the store, allowing it to curate a specific product lineup aligned with promotional goals, inventory priorities, or thematic campaigns. According to some embodiments the Store's Choice control may be actuated during a show booking process of the invention, or upon a seller's entry into a live show through the green room. Once enabled, the store has full control to add products to the live selling session, either one at a time or collectively as a batch. The system dynamically updates the seller's live session interface to reflect the products added by the store in real-time, allowing the seller to present the items accordingly. The Store's Choice feature streamlines product curation and maintains brand alignment across collaborative selling sessions, while also supporting automated inventory linkage and promotional synchronization between store and seller accounts.

After the seller makes its selections of time slot and the products it wishes to promote during the booking, the show may be booked without further approval by the store. However, some embodiments may allow for additional approvals by the store even though the seller's options were restricted to those which were deemed acceptable by the store. That is to say, while further approvals by the store may be built into an embodiment, they are not a requirement of the invention. One way this optional limitation may be embodied in a software is to encode a method whereby a seller selects products that it wishes to promote in a live streaming event at a chosen date and time. Rather than immediately scheduling the live stream, the seller's selections are treated as a proposal that the store is given an opportunity to review and approve. As a practical matter this provides the store with the flexibility to account for changes in inventory and availability that may not be reflected in the current permissions.

Embodiments may provide interactive GUI controls for adding products to a live show product list one at a time, or in groups referred to herein as collections, or even a store's entire catalog can be added to the live show through a single actuation of a GUI control. Once added by the seller and, if applicable, approved by the store, the products remain available for purchase by buyer-users at any time unless sold out, or removed from the product list by the seller or store. Some embodiments provide features for the seller and/or store to control the order in which products are presented in a live show according to the order of the Collection list as recorded e.g. in a variable (e.g. list_of_product_ids) of a Store Collection Table (also referred to herein in concatenated form as StoreCollectionTable to indicate a particular data structure). Additionally, once a seller and store are affiliated, the seller can be free to compile collections independent of a live streaming show. For example, a seller may construct a collection and post it on the seller's social media accounts where the seller's followers can interact with the collection and make purchases from it. Any sales made in this way would be subject to the commission rate agreed between the seller and store, and the collection may persist on the seller's social media for as long as the products remain available from the store for purchase.

While embodiments provide for dual video streams of the seller and store, the person of ordinary skill will understand that the place where a seller conducts its live show is flexible. It may even include conducting the show in person at the brick-and-mortar store. Features of an embodiment that coordinate this remote versus in-person scheduling option are provided. Such features include, without limitation, a GUI control adapted to take user input indicating whether the a particular live show will be broadcast in-person. Moreover, features further include a store-side GUI control indicating whether an in-person broadcasting option is available. The store may deny access to in-person broadcasting using the control. Further, in-person broadcasting may be an opt-in or opt-out feature. In other words, the default may be to permit sellers to schedule in-person broadcasts, in which case the store would have to opt out to prevent scheduling seller to conduct an on-site show. Alternatively, the default could be to prevent scheduling on-site live shows, in which case the store would have to opt in to permit them. In some embodiments a Store may even allow all Sellers to show up on location without any notice and start selling immediately. The platform may provide stores with signs to display in an area highly visible to the public indicating e.g.,“LIVE SELLING WELCOMED. Powered By Jatango”.

Turning to FIG. 1B, a continuation of process 100 is shown starting with steps 105 and 105′. The process continues from 105′ to step 106, where the seller is provided with a link to the store's Add Product Page. In the Add Product Page, the seller views a catalog of products, typically including product photos and descriptions, and prices. The seller is provided here with a GUI control allowing the seller to select one or more products and add them to a collection 107, which the seller will later promote through a live-streaming ecommerce event on behalf of the store. The seller is also provided with a Store's Choice control deferring product selections to the store. During the show, customers may purchase the item currently being demonstrated by the seller, or the customer can scroll through the collection and make a purchase from there.

Optionally, the seller may be provided with a screen summarizing its selections to verify that the correct selections have been made, and make any modifications that may be necessary prior to booking the show. When satisfied with its selections, the seller confirms 108 the selections by actuating a confirmation control of the GUI e.g., an interactive “confirm” button. The seller is transported to a next screen containing scheduling controls for selecting a time and date to book a live-stream 109. Again, the pool of products and booking time slots from which the seller selects are curated by the store to limit the seller's options to those which are already deemed acceptable by the store. Nonetheless, in this embodiment a step 110 is provided where the store must approve the seller's selections, and may suggest alternatives. In cases where a live show does not include the store's participation, it may be unnecessary to coordinate schedules with the store. Therefore, the seller may be provided with permission to go live at will.

The person skilled in the art will readily understand that the sequence of steps in FIGS. 1A and 1B may vary without departing from the scope of the invention. Particularly, step 109 (selecting time slots) could be before step 107 (selecting products). Additionally, certain process steps are arranged in FIGS. 1A and 1B to indicate logical relationships that do not necessarily correspond to chronological relationships. Particularly, step 110 may occur after step 114 in time. Nonetheless it is shown to branch from step 109, because at this point the seller has made key selections subject to the store's approval, namely, products and timing.

Continuing with FIG. 1B, at step 111 the seller adds descriptive matter to its booking which will be customer-facing when the show is published on the platform embodiment. Typical descriptive matter includes, without limitation, photos of the store and/or seller, a clickable link to the store and/or seller's profile page, a show title e.g., Spring Blowout, a narrative briefly describing what the consumer will experience during the show, and photos of products that the seller will promote. In step 112 the seller selects social media channels to which the show will be streamable. This selection is made by actuating GUI controls corresponding to particular social media integrations. For instance, the embodiments of the platform may integrate with Facebook, TikTok, YouTube, Instagram, and so on through published APIs. In one embodiment, the social media channels selected in this step 112 correspond to the seller's social media accounts. In other embodiments the social media accounts correspond to those of the store. And in still others, the social media accounts may be those of the seller, the store, or both the seller and store. Embodiments may provide similar social media channel selection controls to both the seller and store so that both can indicate their own social media accounts where the live show may be streamed.

According to an embodiment of the invention, integration with social media platforms may include a dynamic link which is automatically sent to the selected social media platform and displayed in predetermined areas thereof. The behavior of such a dynamic link may depend on factors including, without limitation, the user's device, and/or the social media platform from which the user engages with the dynamic link. For example, a user engaging the live stream through Facebook using an iPhone may have a different experience than a user engaging through TikTok using a tablet computer or android smart phone. Differences can include whether the screen splits into a dual video stream display, how the dual stream is displayed, placement sizing and form of the product carousel, and so on.

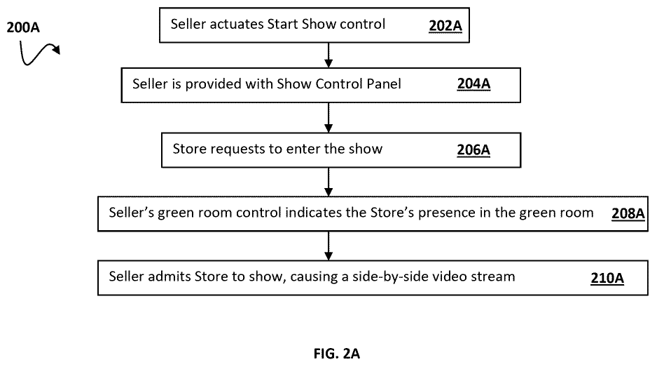

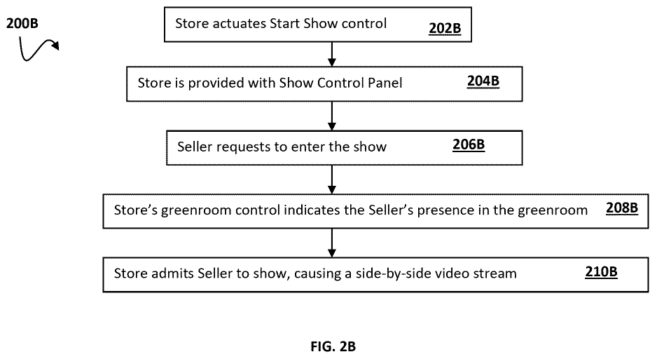

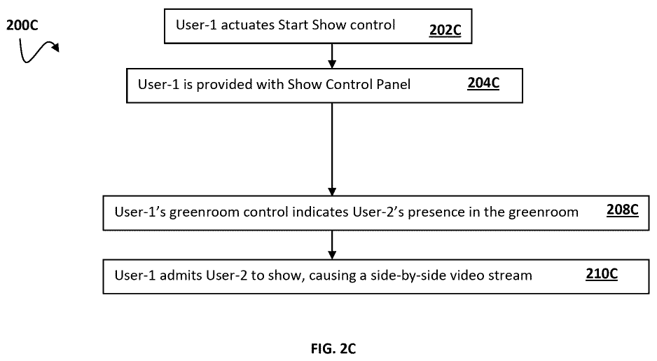

Turning to FIG. 2A, a process 200A for a seller starting a live streaming ecommerce event is illustrated according to an embodiment of the invention. The process begins with the seller actuating a start show control in step 202A, which transports the seller to a screen where it is provided with a show control panel 204A. The show control panel includes a Go Live control, a chat control, and a greenroom control. The Go Live control begins a live stream when actuated. The chat control is a multiplatform chat that provides buyer-users on various social media platforms where the live streaming event is broadcast with means to interact with the seller, the store, and each other in real time. The greenroom control allows other presenters to enter the show at the discretion of a predetermined user, which in this case is the seller. According to some embodiments, the user that actuates the start show control is assigned control over admitting guests from the greenroom. For instance, the store may need to participate in a seller's live streaming events because the seller may not have product on hand to display or demonstrate. This role can be filled by a representative of the store, interacting with the platform through a store-user account, taking part in the live stream. The greenroom allows others, like the store representative, or any user including a buyer-user, to join while the seller maintains control of the store-user's participation in the show.

Optionally, users may be granted access to enter a greenroom only upon invitation, by the seller accepting a request made by the user wishing to enter, or by some affirmative act of the seller. Accordingly, the greenroom control provides the seller with a visual and/or audio indication that a presenter (e.g. a store-user) or other guest (e.g. a buyer-user providing a testimonial) is waiting to be admitted to the live stream, including the identity of the presenter, and it provides the seller with controls for admitting and optionally removing a presenter from a show. The user may also be provided with GUI controls for removing itself from the greenroom.

With continuing reference to FIG. 2A, at step 206A a user of the store account requests to enter the show through the greenroom. The request may comprise a message to the seller according to known messaging protocols, and/or the request may be limited to a visual indication of the seller's presence in the greenroom 208A. An audible indication may be provided in addition to or instead of the visual indication. For instance, the platform may issue an audio instruction to the seller's computer to play a predetermined tone or tones. Knowing that the store representative is in the greenroom and ready to go live, the seller may make an introduction and then admit the representative to the live stream show 210A. At that point the store representative's video feed is displayed side by side with that of the seller. Therefore, all users including the seller, the store representative, and the consumer audience see both video streams live in real time, along with the multiplatform chat control. The person of ordinary skill will recognize that the invention is not limited to two video streams. Rather, any number of video streams may be broadcast simultaneously. For example, a seller may be promoting a given product for a store in a first video stream. The store may have a representative demonstrating the product in a second video stream. And, a buyer may be present in a third video stream to provide a testimonial when prompted by the seller.

According to some embodiments, a similar process can be carried out by the store, as illustrated in FIG. 2B. A process 200B for starting a live streaming ecommerce event is illustrated beginning with the store, rather than the seller, actuating a start show control in step 202B, which transports the store-user to a screen where it is provided with a show control panel 204B. The show control panel includes a Go Live control, a chat control, and a greenroom control. The Go Live control begins a live stream when actuated. The chat control is a multiplatform chat that provides buyer-users on various social media platforms where the live streaming event is broadcast with means to interact with the store, the seller, and each other in real time. The greenroom control allows other presenters to enter the show at the discretion of a predetermined user, which in this case is the store-user. The seller may need to participate in a store's live streaming events because the store may not otherwise have access to the seller's social media followers, or the seller's talent. The greenroom allows others, like the seller to join while the store maintains control of the seller-user's participation in the show.

With continuing reference to FIG. 2B, at step 206B a user of the seller account requests to enter the show through the greenroom. The request may comprise a message to the store-user according to known messaging protocols, and/or the request may be limited to a visual indication of the seller's presence in the greenroom 208B. An audible indication may be provided in addition to or instead of the visual indication. For instance, the platform may be caused to issue an audio instruction to the store-user's computer to play a predetermined tone or tones. Knowing that the seller-user is in the greenroom and ready to go live, the store may make an introduction and then admit the seller to the live stream show 210B. At that point the seller's video feed is displayed side by side with that of the store-user. Therefore, all users including the store, the seller, and the consumer audience see both video streams live in real time, along with the multiplatform chat control. The person of ordinary skill will recognize that the invention is not limited to two video streams. Rather, any number of video streams may be broadcast simultaneously. For example, a seller may be promoting a given product for a store in a first video stream. The store may have a representative demonstrating the product in a second video stream. And, a buyer may be present in a third video stream to provide a testimonial when promoted by the seller.

In some embodiments a user initiating a live stream, such as a store, can bypass the usual process of inviting another user to join, or waiting for a user to request admission from a green room. One such embodiment 200C is illustrated in FIG. 2C. A first user, which could be a store or a seller, actuates the start show control 202C, and is provided with a show control panel 204C. The user goes live, and notices that a guest, “User-2” is in the green room 208C, possibly because the users previously agreed to cooperate on the present live stream, or possibly by chance. According to this embodiment 200C, the process moves direct to User-1 admitting User-2, causing User-2's video to stream side-by-side with that of User-1, without User-2 having to request access or approve activation of its camera and streaming of its video feed.

The person having ordinary skill in the art will readily understand that video feeds may be streamed directly by the platform embodiment to selected social media channels or, as a matter of design choice, video feeds may be passed to a third-party restreaming service which are well known in the art. Such restreaming services receive a plurality of video feeds, and coordinate and relay the video streams to the selected social media channels.

Embodiments of the invention include live streaming shows having multiple simultaneous sellers. The plurality of sellers grouping themselves into one live streaming show enables them to expand their social media reach by combining their followers. Each member of the common pool of followers is notified of the event. Therefore, sellers are able to reach individuals to whom they are not themselves connected. In one embodiment, each of the plurality of simultaneous sellers takes turns pitching their products to a common audience. In another embodiment, each of the plurality of sellers is allocated to a kiosk and are enabled to pitch their products without further coordination with other sellers. In this embodiment, a buyer-user enters a show space analogous to an open-air market or a shopping mall. The buyer-user can choose to focus on a given seller that catches the buyer-user's interest, and may move on from kiosk to kiosk making purchases from individual sellers or simply window-shopping. For example, thumbnail video feeds may be simultaneously provided to the buyer-user, while the corresponding audio feeds are either muted or set to a low volume level until the buyer-user shifts focus to a particular feed. Focus may be shifted by, for instance, clicking or tapping the feed. Upon shifting focus to a particular feed, the platform may automatically raise the audio volume and enlarge the video feed to make both more prominent relative to the other sellers.

### Store-Seller Affiliation Model

Platform embodiments manage a many-to-many relationship between stores and sellers. In part this done by assigning unique user IDs to each user account, so that each seller/influencer and each seller/store is identified by a unique code suitable for recording in a database, which enables a structured collaboration between users. According to an embodiment of the invention, the fundamental act of forming an affiliate relationship is recording a seller ID (seller_id) in a store affiliate table (StoreAffiliateTable), although this event is typically subject to approval by one party or the other. This event causes a state change in the platform that enables two users to interact in a store-seller affiliation relationship, in accordance with the invention. The state change is defined by permissions settings that regulate how the seller and store are allowed to interact in terms of the data and features that each is permitted to access.

Formation of the affiliate relationship between users is governed by an approval process that enforces business rules to allocate control over scheduling tasks and product selection. Control is maintained with a permissions regime controlling access to data, and approval requirements that require the owner of data to consent to another's particular uses of data to which it has been granted access.

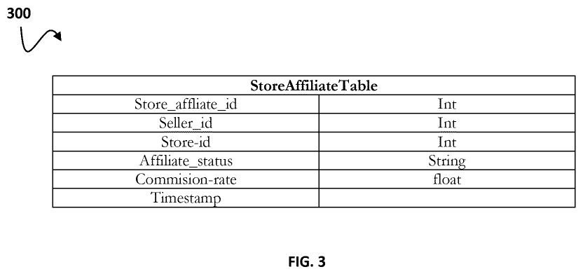

A process of connecting sellers and stores according to one embodiment of the invention begins with initiating a request to connect. Either a seller or a store user can initiate a request to connect. The request is recorded in a database table along with the user IDs and a status such as pending, approved (or accepted), or rejected. The user IDs are associated with a party field indicating whether the user is the initiator or the recipient of a request. A timestamp may also be recorded in the table, indicating when the request was made. FIG. 3 illustrates the structure of a request 300 according to one embodiment. The two columns in FIG. 3 are a list of variables on the left, and their corresponding data types on the right.

The person having ordinary skill in the art will understand that the example tables shown herein are not meant to limit the invention to specific examples. Rather, different software engineers will of ordinary skill may structure the tables differently, as a matter of design choice, in any suitable computer language without departing from the scope of the invention. Regarding the example shown in FIG. 3, the table is labeled StoreAffiliateTable. The unique user IDs of the seller and store are both included (Seller_id and Store_id) along with their data type, which in this embodiment is an integer, however, the person of ordinary skill will recognize that other datatypes may be used as a matter of design choice. For example, a string data type is also acceptable for user IDs, and may be more versatile in certain instances. Similarly, the affiliation itself is assigned an ID, labeled Store_affliate_id. The status of the affiliation is recorded as a string, which, as mentioned above, may be a human-language word like “pending”, “accepted”, or “rejected”. A commission rate agreed to by the seller and store is included as floating point. And finally, the affiliation data is time-stamped. The time and date used to make the time stamp is selected as a matter of design choice, but typically may be the time and date that the request to connect is made or the time and date that the affiliation request is accepted. The data structure may even include both, again, as a matter of design choice.

When a request to for an affiliation is accepted, the information recorded in a StoreAffiliateTable data structure is used to govern the relationship between the two parties, defining permitting interactions. For instance, it is used to support retrieval of data, data filtering, and data access control. With respect to data access control by a seller/store, permissions are enforced according to the store's preferences so that all the seller-affiliate's actions upon the store's data are constrained by the store's predefined conditions.

In effect, the permissions that the platform allows a user-account to manage and enforce against other users, defines the user's role. For example, the platform embodiment provides stores with configurable permissions defining whether seller-affiliates in general, or even a particular seller-affiliate, can access certain product data for selection and addition to a collection that the seller may later offer for sale in a live-streaming event. Other permissions may control whether any users other than the store can view certain product data. For example, product data may be uploaded to the platform in preparation for selling a product, but the data may remain in unpublished draft form until the store's product page is ready to go live. Until then, other users may not have permission to view the product data or place orders. In the event that a request is rejected, the request (i.e. the StoreAffiliateTable) may still be retained for record keeping, but no affiliation relationship is formed.

In one embodiment, upon formation of an affiliate relationship, the platform embodiment updates Role-Based Access Control (RBAC) according to the OAuth 2.0 framework, transitioning the user from a customer role to a shop affiliate role as a seller-user. This grants the seller-user the permission to create collections of a store's products for the seller-user's promotion, schedule a live show in the affiliated store, go live for the scheduled show if approved by the store, and share affiliate-specific collection links for tracking purposes and commission credit.

An application of data filtering according to embodiments of the invention is found in the live-show scheduling features. Before a seller can schedule a show, the system checks and enforces seller-defined constraints such as availability widows and blackout periods. Such constraints may be important to the store if the store must provide a representative to participate in the live streaming event, or if the product that the seller wishes to represent is out of stock. The platform embodiment may further filter out timeslots where the seller already has an event scheduled, thereby avoiding scheduling conflicts. Due to this dynamic filtering of timeslots based on constraints of both the store and the seller, when the seller selects a timeslot, agreement between the parties can be inferred. This results in a time-limited grant of permission by the store to the seller, allowing the seller to conduct a live-stream of the store's products only during the timeslot. In the absence of such permission, the seller would not be enabled to go live with the store's products, and would be unable to collect a commission of sales made.

In some embodiments, although the seller is constrained to engage in a live show according to the store's conditions, once the show occurs the product carousel remains active. Therefore, buyer-users can view the show at any time and still use the product carousel to make purchases for as long as the products are available. Moreover, the seller will continue to earn commissions for such sales long after the live show ends. Embodiment may further include carousels that are populated from the start of a live show with all products that will be promoted during the show. Therefore, during a live show users can make purchases of any product in a collection regardless of whether the product has not yet been presented in the show.

The platform embodiment tracks commissions by associating a seller ID with transactions. For instance, every time an audience member clicks a buy button in the context of a seller's livestreaming ecommerce event, that seller's user ID is recorded with the purchase and thereby credited to the seller. This tracking is tied to the StoreAffliliateTable, which enables automated commission calculations and payments based on the commission data recorded in the StoreAffiliateTable and banking information associated with the seller's user ID. According to one embodiment of a platform embodiment an affiliate relationship 400 is structured as shown in FIG. 4. FIG. 4 illustrates the interrelationship of five data tables, an AffliliateCommissionTable 402, a ShopePaymentsTable 404, a StoreCollectionTable 406, a ShowTable 408, and a StoreAffiliateTable 300. The StoreCommissionTable 402 is used to route commission payments (commission_amount 402a) to an affiliation (store_affiliate_id 402b), which ultimately relates back to a seller to whom particular sales are attributed through the StoreAffiliateTable. The ShopPaymentsTable 404 relates product sales (transaction_amount 404a) to the live show (show_id 404b) where the product was sold. The StoreCollectionTable 406 relates products (list_of_product_ids 406a) to an affiliate relationship (store_affiliate_id 406b), in effect placing products in a collection of products for promotion by a seller by relating the product list 406a to a particular seller ID through the StoreAffiliateTable 300. The ShowTable 408 relates particular products to a show. The table includes the list_of_product_ids record 406a and the show_id record 404b, which is labeled in table 408 as the primary key (PK). According to the illustrated embodiment, table 408 also relates these records to a particular affiliation relationship (store_affiliate_id) and commission rate (commission_rate). Finally, the StoreAffiliateTable 300 relates a seller to a store, which is the fundamental element of the affiliate relationship.

Another way of describing the affiliate relationship is that it is a system-level event characterized by a database entry whereby a seller_id is recorded in a StoreAffiliateTable with a store_id. This event triggers a role-based access control update whereby the seller's permissions are updated, unlocking affiliate functions. Among those functions is the tracking system for seller-attributed sales, and calculation of commissions due. Live streaming capabilities are also unlocked, permitting the seller to schedule and go live with a show upon approval by the store. This amounts to a state change of the software providing a clear technical framework of structured access control, sales tracking, and monetization mechanisms.

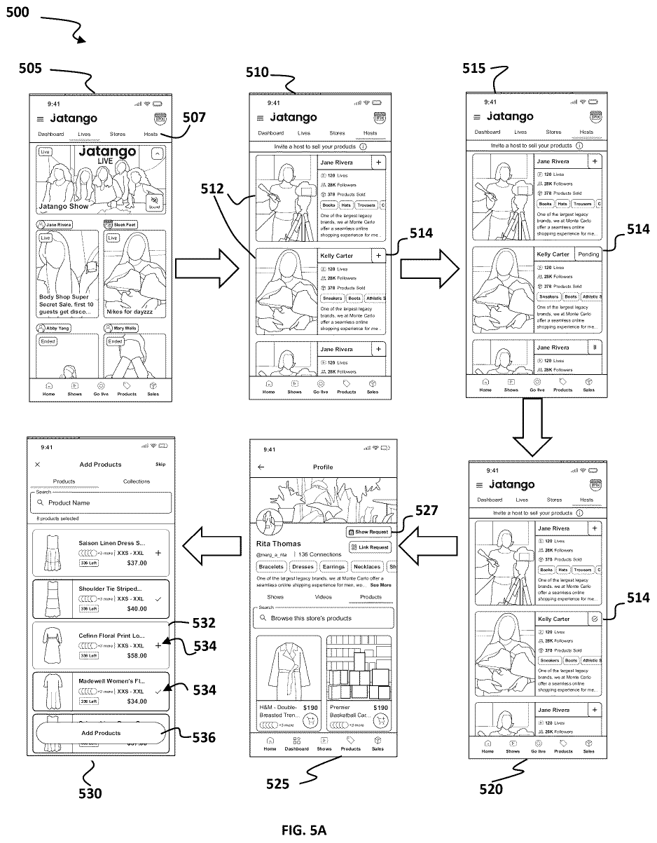

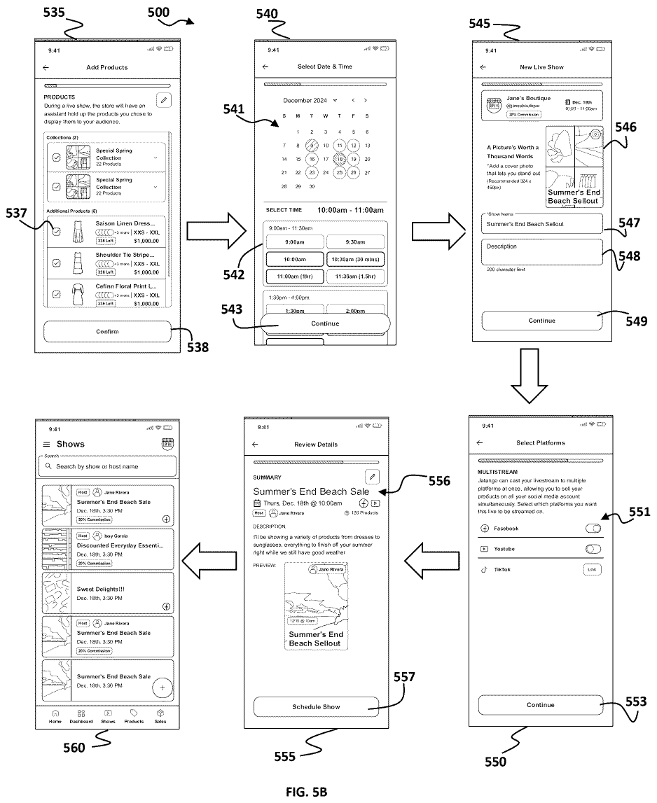

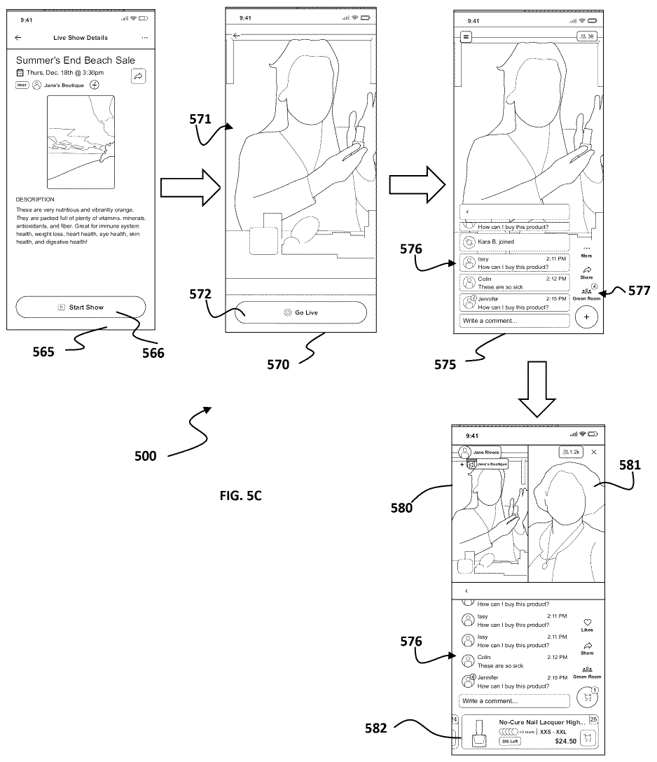

Turning to FIGS. 5A through 5C, a process 500 according to an embodiment of the invention is illustrated whereby a store affiliates with a seller and executes a live streaming ecommerce event with the seller. The example process according to FIG. 5A, begins on a home screen 505, where a user of a store account clicks a selectable enumeration of sellers embodied in a sellers tab 507. The person having ordinary skill in the art will recognize that the home screen need not be the only way to begin a process of affiliating a store with a seller. Rather, this example is selected as a matter of convenience for the purpose of nonlimiting illustration only. Clicking the selectable enumeration of sellers brings the focus of the GUI to the seller tab and the enumeration of sellers that it contains, as shown in screen 510. From here, the store account user can browse an interactive and information-dense set of tiles 512 representing seller accounts. In this example, tiles for the sellers Jane Rivera and Kelly Carter are shown, among others. They include a photo of the influencer and key data that a store needs to make informed decisions about affiliating with a seller such as, without limitation, number of followers, the seller's experience with live streams, the number and kind of products the seller has sold, and a short narrative. The store account user is provided with well-known scrolling features to scroll through the selectable enumeration of seller tiles. For example, embodiments operating in a smart phone or tablet computer environment may provide for a tap and drag gesture, while embodiments running in a desktop environment may instead provide scroll bar controls. In some embodiments, clicking or tapping a seller's tile, sometimes also referred to as a card, transports the user to the seller's full profile where further details may be available. Add Seller controls can be made available to the store in multiple locations throughout the platform embodiment as a matter of design choice.

Each tile 512 also includes a means for offering to affiliate with the seller. Specifically, an Add Seller control 514 is provided. In screen 510 the Add Seller control is shown as a plus icon, indicating that there is no present relationship e.g. with Kelly Carter, and no invitation has been sent. Actuating the Add Seller control e.g. by tapping or clicking changes the visual rendering of the control from a plus icon to the word “pending”, as shown in screen 515. The person having ordinary skill in the art will readily understand that the specific choice of visual indicia such as a plus icon and “pending” is a simple matter of design choice, and not a limitation of the invention. This visual change in the Add Seller control 514 corresponds to a human readable message being sent to the seller account offering to affiliate, and providing the seller account user with an interactive means for accepting the invention such as a hyperlink or accept button. The visual change in the Add Seller control 514 also corresponds to a computer readable instruction being communicated to the platform that causes the platform to update a relational database to reflect the fact that an invitation to connect has been sent and that the affiliation relationship is now “pending”.

As shown in screen 520 of FIG. 5, the visual rendering of the Add Seller control 514 has changed again, now to a check mark, indicating that the seller has actuated the means for accepting the store's invitation to connect. At this point the affiliation relationship has been established, again, as indicated by the check mark re-rendering of the Add Seller control 514. This change in visual rendering also corresponds to a computer readable instruction being communicated to the platform that causes the platform to update the relational database to reflect that the invitation to connect has been accepted and that the affiliation relationship is now established.

At this point in the process 500 the seller can request to book a live show with the store, which in this case is Rita Thomas, or the store can invite the seller to book a show with it. In screen 525 the newly affiliated seller account user has navigated to the store, Rita Thomas, and is provided with a button control 527 for initiating a booking. The seller is also provided with the store's full profile and product listings so that it can search for current sales opportunities and explore products that it may wish to represent in a live stream. Actuating the show request control 527 transports the seller to screen 530 where it is provided with GUI controls for beginning the show booking process.

As illustrated in screen 530, the booking process of the present embodiment begins with selecting products from the store's catalog. Items in the catalog are represented by product tiles 532 containing information about each product such as a photo, price, the amount remaining in inventory, sizes, colors, and any other details that would inform a consumer's purchasing decision. The product tiles 532 also include Product Selection control 534. The Product Selection control 534 has a plurality of renderings that indicate whether the seller has selected the product for selling in a live streaming ecommerce event. For example, in the “Cefinn Floral Print . . . ” tile 532 the Product Selection 534 control is rendered as a plus “+” icon, indicating that it has not yet been selected for the seller's product list, but is available. In contrast, in the “Madewell Women's . . . ” product tile 532 the Product Selection control 534 is rendered as a check mark, indicating that the seller has selected the product for addition to a product list. Actuating the Product Selection control 534 is a tentative selection. At this step of the process 500, the data generated by actuating the Product Selection control 534 can be stored in a memory on the seller user's local device without being globally available platform-wide. Therefore, in some embodiments the seller-user can change his mind, selecting and deselecting products without adding to network traffic. In screen 530, the illustrated embodiment includes an Add Products 536 button control. Actuating the Add Products control 536 corresponds to sending the selection data through a pub/sub messaging system with instructions to the platform to update the relational database show table 408, reflecting the seller-user's product selections. Specifically, codes identifying the selected products are added to the list_of_product_ids string variable 406a.

Turning now to FIG. 5B, which is a continuation of process 500 begun in FIG. 5A, the seller is transported from screen 530 to screen 535. Having actuated the Add Products control 536 in screen 530, the seller is now provided with an opportunity to review all its selections and confirm. The seller can uncheck products using the check box control 537 to remove items, and then confirm using the confirm button. This action moves the process 500 to screen 540 which provides scheduling tools. More specifically, an interactive calendar 541 is provided with selectable dates. Optionally, the seller may be limited to dates that the store has predetermined to be acceptable for scheduling a live streaming event. Thus, unavailable dates may be grayed out, unselectable, or otherwise inactive. Similarly, the seller may be limited to selecting time slots 542 already designated as acceptable by the store. Upon making its date and timeslot selections the seller can click the Continue button 543.

Clicking the continue button advances the process 500 to screen 545 where the seller adds descriptive promotional information like photos 546, a show name 547, and a description of the show 578 so that buyer-user have some idea of what to expect from the live show. The seller-user can then actuate another Continue button 549, advancing the process 500 to a screen 550 for selecting social media channels 551 where the live stream will be broadcast. More specifically, selecting a social media channel here causes the platform embodiment to send a link to the seller's account on the selected social media platform. Therefore, all the followers of the seller will be notified of the upcoming live streaming event through a variety of means including messaging from the seller, and updates to the followers′feeds initiated through the social media platform. Upon making the desired selections, the seller actuates another Continue button 553, advancing the process to screen 555 where the seller conducts a final review. Selected details 556 of the live stream as summarized on screen 555 such as the title of the live stream, the date and timeslot when it will be held, and so on. When the seller is satisfied, the seller actuates the Schedule Now button 557. This act updates a relational database embodying a scheduled live show. The process now advances to screen 560 where the seller sees a list of live show tiles. The list may be a list of the seller's live shows, or it may be any other predetermined list of live shows. In some embodiments, the show that the seller just scheduled may be displayed.

The seller can select any one of its scheduled shows from the list of shows which opens a details screen 565 shown in FIG. 5C. In screen 565, the seller has opened the live show created in the process illustrated in this series of FIGS. 5A-5C. The seller can begin the go-live process by selecting the Start Show button 566. The process 500 now advances to screen 570. This step of the process 500 activates the seller's local camera and/or microphone, the feed of is the camera being shown in screen 570 as element 571. The final step of the go-live process, in terms of actions taken by the seller-user, is to actuate the Go Live button 572. Doing so advances the process to screen 575 which shows new features activated in response to actuating the Go Live button 572. Namely, a multiplatform chat feature 576 is enabled, showing chat streams from a plurality of users participating from different social media platforms, and a green room feature 577 is also enabled. The green room 577 is a waiting area for participants who wish to participate in the live show as a presenter. In this embodiment the user that initiated the live streaming show by actuating the Go Live button 572 is the user in control of the green room 577. In this illustration, the seller has initiated the live stream, and therefore the seller decides whether or not to allow users in the green room to participate as a presenter. As used here, the act of allowing a user to participate means to choose to stream the user's video feed. In the illustrated process, the seller admits a store representative to the live show, advancing the process to screen 580. The video feeds of the two participants, seller and store, now appear side by side 281 in screen 580 with the chat control 576 appearing underneath. A product carousel 582 is also shown at the bottom of screen 580 displaying the products being promoted through the live show. The tiles in the carousel 582 are interactive. Therefore, clicking a product tile can have one of a plurality of predetermined results including, without limitation, opening a product details screen where a buyer-user can learn more about the product, or adding the product to a shopping cart.

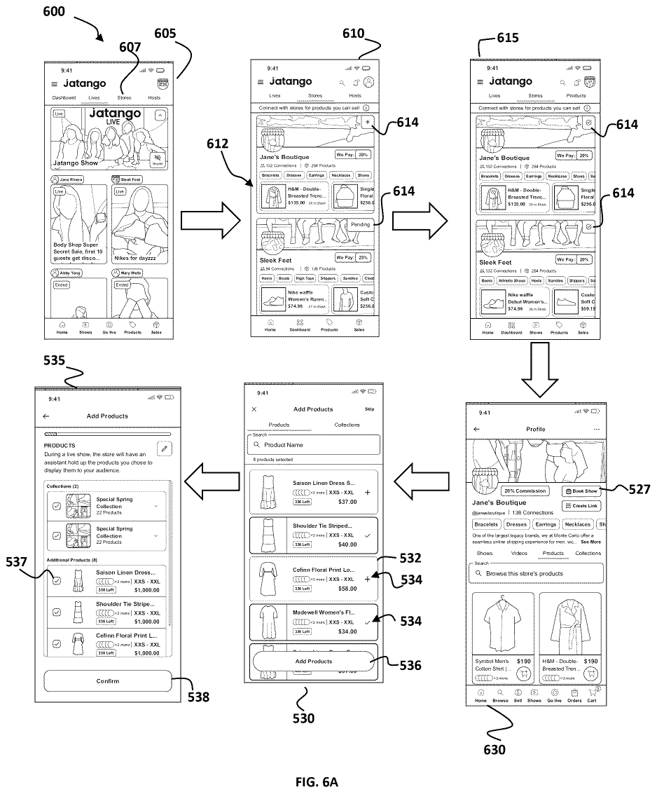

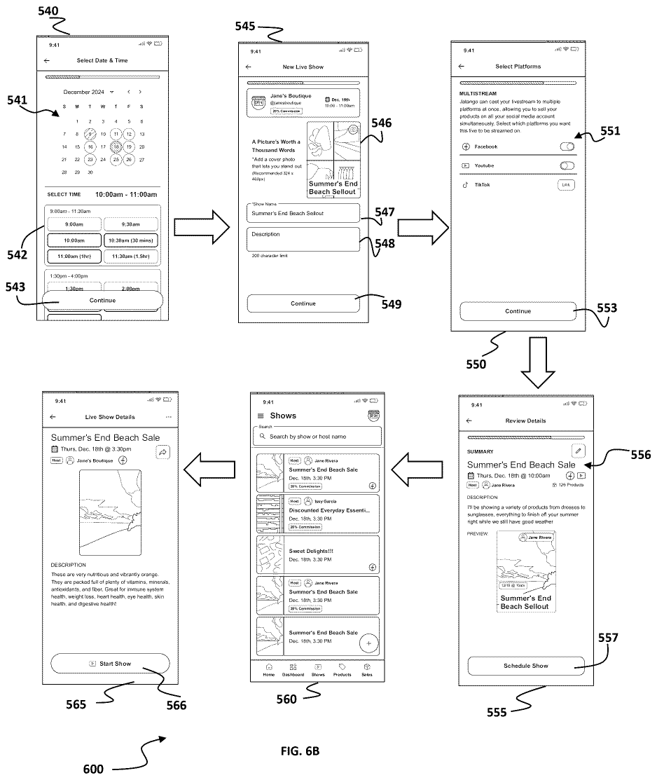

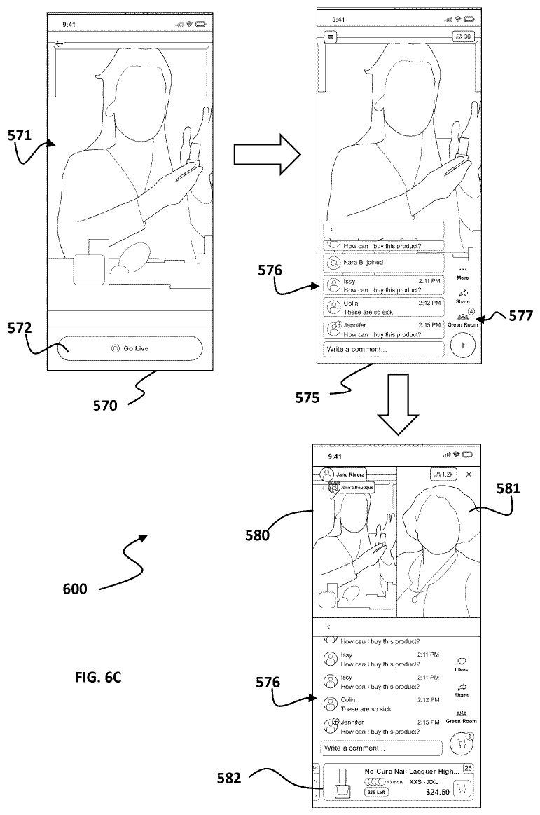

Turning now to FIGS. 6A through 6C, a process similar to that of FIGS. 5A through 5C is shown. This time the process is illustrated from the point of view of a seller connecting with a store, rather than a store connecting with a seller. The process begins on a home screen 605, where a user of a seller account clicks a selectable enumeration of stores embodied in a stores tab 607. This brings the focus of the GUI to the store tab and the enumeration of stores that it contains, as shown in screen 610. From here, the seller account user can browse an interactive and information-dense set of tiles 612 representing seller accounts. In this example, tiles for the stores Jane's Boutique and Sleek Feet are shown. Others remain out of view. They include a photo and name of the store and key data that a seller needs to make informed decisions about affiliating with a store such as the commission offered, and the kinds of products provided.

The seller account user is provided with well-known scrolling features to scroll through the selectable enumeration of store tiles 612. For example, embodiments operating in a smart phone or tablet computer environment may provide for a tap and drag gesture, while embodiments running in a desktop environment may instead provide scroll bar controls. In some embodiments, clicking or tapping a store's tile, sometimes also referred to as a card, transports the user to the store's full profile where further details may be available.

In addition to key information, each tile 612 also includes a means for offering to affiliate with the store. Specifically, an Add Store control 614 is provided. In screen 610 the Add Store control is shown in two different renderings representing two different states. In one instance it is shown as a plus icon, indicating that there is no present relationship e.g. with Janes Boutique, and no invitation has been sent. In a second instance, the Add Store control is rendered as a box containing the word “Pending” 614, indicating that an invitation to connect has been sent to Sleek Feet but has not yet been accepted. The person having ordinary skill in the art will readily understand that the specific choice of visual indicia such as a plus icon and “pending” is a simple matter of design choice, and not a limitation of the invention. This visual change in the Add Store control 614 corresponds to a human readable message being sent to the store account offering to affiliate, and providing the store account user with an interactive means for accepting the invention such as a hyperlink or accept button. The visual change in the Add Store control 614 also corresponds to a computer readable instruction being communicated to the platform that causes the platform to update a relational database to reflect the fact that an invitation to connect has been sent and that the affiliation relationship is now “pending”.

As shown in screen 515 of FIG. 6A, the visual rendering of the Add Store control 614 has changed. The Add Store control of both Jane's Boutique and Sleek Feet is rendered as a check mark, indicating that the store has actuated the means for accepting the seller's invitation to connect. At this point the affiliation relationship has been established, again, as indicated by the check mark re-rendering of the Add Store control 614. This change in visual rendering also corresponds to a computer readable instruction being communicated to the platform that causes the platform to update the relational database to reflect that the invitation to connect has been accepted and that the affiliation relationship is now established.

At this point in the process 600 the store can invite the seller to book a live show with the store, which in this case is Jane's Boutique, or the seller can initiate booking without prompting from the store. In screen 630 the newly affiliated seller account user has navigated to the store, Jane's Boutique, and is provided with a button control 527 for initiating a booking. The seller is also provided with the store's full profile and product listings so that it can search for current sales opportunities and explore products that it may wish to represent in a live stream. Actuating the show request control 527 transports the seller to screen 530 where it is provided with GUI controls for beginning the show booking process. From this screen the process 600 is identical to that of process 500.

As illustrated in screen 530, the booking process of the present embodiment begins with selecting products from the store's catalog. Items in the catalog are represented by product tiles 532 containing information about each product such as a photo, price, the amount remaining in inventory, sizes, colors, and any other details that would inform a consumer's purchasing decision. The product tiles 532 also include Product Selection control 534. The Product Selection control 534 has a plurality of renderings that indicate whether the seller has selected the product for selling in a live streaming ecommerce event. For example, in the “Cefinn Floral Print . . . ” tile 532 the Product Selection 534 control is rendered as a plus “+” icon, indicating that it has not yet been selected for the seller's product list, but is available. In contrast, in the “Madewell Women's . . . ” product tile 532 the Product Selection control 534 is rendered as a check mark, indicating that the seller has selected the product for addition to a product list. Actuating the Product Selection control 534 is a tentative selection. At this step of the process 500, the data generated by actuating the Product Selection control 534 can be stored in a memory on the seller user's local device without being globally available platform-wide. Therefore, in some embodiments the seller-user can change his mind, selecting and deselecting products without adding to network traffic. In screen 530, the illustrated embodiment includes an Add Products 536 button control. Actuating the Add Products control 536 corresponds to sending the selection data through a pub/sub messaging system with instructions to the platform to update the relational database show table 408, reflecting the seller-user's product selections. Specifically, codes identifying the selected products are added to the list_of_product_ids string variable 406a.

Having clicked the Add Products button 536 the seller is transported from screen 530 to screen 535. The seller is now provided with an opportunity to review all its selections and confirm. The seller can uncheck products using the check box control 537 to remove items, and then confirm using the confirm button. This action moves the process 600 to screen 540 of FIG. 6B, which provides scheduling tools. More specifically, an interactive calendar 541 is provided with selectable dates. Optionally, the seller may be limited to dates that the store has predetermined to be acceptable for scheduling a live streaming event. Thus, unavailable dates may be grayed out, unselectable, or otherwise inactive. Similarly, the seller may be limited to selecting time slots 542 already designated as acceptable by the store. Upon making its date and timeslot selections the seller can click the Continue button 543.

Clicking the continue button advances the process 600 to screen 545 where the seller adds descriptive promotional information like photos 546, a show name 547, and a description of the show 578 so that buyer-user have some idea of what to expect from the live show. The seller-user can then actuate another Continue button 549, advancing the process 600 to a screen 550 for selecting social media channels 551 where the live stream will be broadcast. More specifically, selecting a social media channel here causes the platform embodiment to send a link to the seller's account on the selected social media platform. Therefore, all the followers of the seller will be notified of the upcoming live streaming event through a variety of means including messaging from the seller, and updates to the followers' feeds initiated through the social media platform. Upon making the desired selections, the seller actuates another Continue button 553, advancing the process to screen 555 where the seller conducts a final review. Selected details 556 of the live stream as summarized on screen 555 such as the title of the live stream, the date and timeslot when it will be held, and so on. When the seller is satisfied, the seller actuates the Schedule Now button 557. This act updates a relational database embodying a scheduled live show. The process now advances to screen 560 where the seller sees a list of live show tiles. The list may be a list of the seller's live shows, or it may be any other predetermined list of live shows. In some embodiments, the show that the seller just scheduled may be displayed.

The seller can select any one of its scheduled shows from the list of shows which opens a details screen 565. In screen 565, the seller has opened the live show created in the process illustrated in this series of FIGS. 6A-6C. The seller can begin the go-live process by selecting the Start Show button 566. The process 600 now advances to screen 570 of FIG. 6C. This step of the process 600 activates the seller's local camera and/or microphone, the feed of the camera being shown in screen 570 as element 571. The final step of the go-live process, in terms of actions taken by the seller-user, is to actuate the Go Live button 572. Doing so advances the process to screen 575 which shows new features activated in response to actuating the Go Live button 572. Namely, a multiplatform chat feature 576 is enabled, showing chat streams from a plurality of users participating from different social media platforms, and a green room feature 577 is also enabled.

The green room 577 is a waiting area for participants who wish to participate in the live show as a presenter. In this embodiment the user that initiated the live streaming show by actuating the Go Live button 572 is the user in control of the green room 577. In this illustration, the seller has initiated the live stream, and therefore the seller decides whether or not to allow users in the green room to participate as a presenter. As used here, the act of allowing a user to participate means to choose to stream the user's video feed. In the illustrated process, the seller admits a store representative to the live show, advancing the process to screen 580. The video feeds of the two participants, seller and store, now appear side by side 281 in screen 580 with the chat control 576 appearing underneath. A product carousel 582 is also shown at the bottom of screen 580 displaying the products being promoted through the live show. The tiles in the carousel 582 are interactive. Therefore, clicking a product tile can have one of a plurality of predetermined results including, without limitation, opening a product details screen where a buyer-user can learn more about the product, or adding the product to a shopping cart.

### Inventory Holds

Some embodiments may include a shopping cart feature adapted to place an inventory hold on items selected by a customer but not yet purchased. More specifically, a buyer-user may begin a transaction by adding a product promoted on a livestream to an ecommerce shopping cart. The shopping cart communicates the selection to an inventory system causing it to reserve a corresponding number of the selected product or products. By making such reservations, customers and stores are both protected from inadvertent over-selling whereby an order is placed but cannot be fulfilled. When the customer makes payment the inventory reserve is converted to a permanent deduction from inventory available for sale. Conversely, if payment is not made within a predetermined time the inventory hold is lifted, and the previously reserved quantity is available for purchase.

In one very specific example of inventory holds according to embodiments of the invention is an event sourced application suitable for distributed computing environments. The Marten . NET library is used to leverage PostgreSQL as an event store, which enables the embodiment to store events and then replay them to reconstruct the state of the application. The Dapr (distributed application runtime) runtime may be used with Marten to enable state management and pub/sub messaging communications, where Marten handles the storage and replay of events, and Dapr provides the infrastructure and APIs for state management and communication between microservices. The result is a system where the state of the embodiment in terms of inventory available for sale can be reconstructed reliably by replaying events.

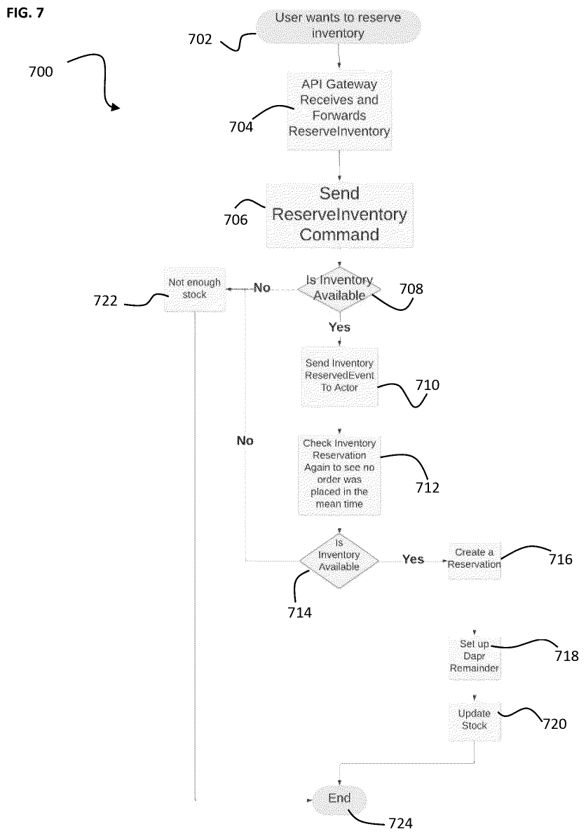

An example 700 of how Marten and Dapr can cooperate in accordance with the invention is illustrated with reference to FIG. 7. A buyer-user initiates an inventory reservation 702 by adding an item of inventory to a shopping cart or similar ecommerce tool. The Dapr API gateway receives and forwards 704 a command indicating the inventory reservation to a Dapr actor. For purposes of illustration the command is denoted ReserveInventoryCommand 706. The Dapr actor reconstructs the current inventory state by replaying past events stored by Marten in a relational database thereby determining available inventory 708. If the Dapr actor establishes that sufficient inventory is available for purchase it causes a reservation command to be issued 710 to another Dapr actor, including a configurable expiry. The other Dapr actor double checks inventory availability 712. If available inventory is found 714 the actor creates the reservation and sets up a reminder 716 to track the expiration time of the reservation. The actor then publishes the inventory reservation (InventoryReservedEvent) and updates the quantity available for purchase 720 and the process 700 terminates 724. On the other hand, if the Dapr actor determines at step 708 that inventory is insufficient to fulfill an order, the actor rejects the reservation request (ReserveInventoryCommand) 722 and the process 700 terminates 724. Embodiments may further include visual indicia for the benefit of users indicating the number of units available for purchase as the quantity changes in real time. Therefore, when items are sold out, the user may be informed that item is unavailable with a visually perceptible message such as “Sold Out”.

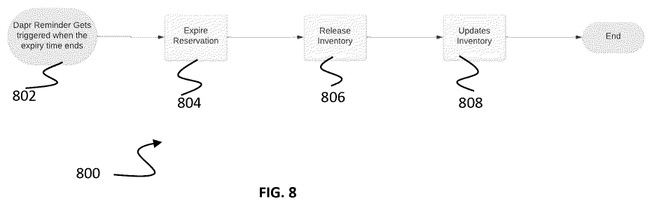

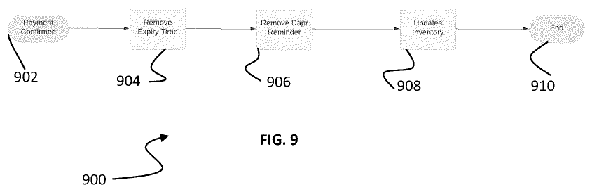

Turning now to FIG. 8, a Dapr reminder process 800 is illustrated. When the expiry period runs the Dapr reminder triggers 802 a command that terminates the inventory reservation. That command is represented here as ExpireReservationCommand. The command causes the Dapr actor (InventoryItemActor) to expire the reservation 804 and release the held inventory 806. The actor then publishes the updated inventory state, which in effect update the inventory 808. With reference to FIG. 9, an alternate process 900 executes if payment is made 902 before the expiry period runs. That case a Dapr actor issues a command removing the expiration time 904 from the reservation, which in effect is a permanent. For illustration purposes, the command is referred to as the UpdateReservationCommand. Additionally, the Dapr actor unregisters the reminder 906 thereby ensuring that it can no longer be triggered to release inventory, making it available for purchase. By removing the expiration time and removing the reminder, the previously published inventory state remains in effect 908. Therefore, no additional state publication is necessary to update inventory, and the process 900 can terminate 910.

Upon confirming payment in step 902 of FIG. 9, the order fulfillment process 1000 begins. Order fulfillment is also known in the art as picking and packing. The fulfillment process 1000 includes issuing a command to the Dapr actor, InvenotryItemActor, causing it to confirm inventory 1004. For illustration purposes, the command is referred to as the ConfirmReservationCommand. The Dapr actor processes it by replaying the Marten events to establish the latest inventory state 1006. It further validates the reservation itself by checking that it is still registered, and matches the quantity in the reservation to a quantity in inventory. Upon completion is publishes a new event confirming the reservation. For illustration purposes, the event is referred to herein as the ReservatonConfirmedEvent. The inventory is permanently deducted 1008 from stock at this point and the reservation is removed from a list of active reservations and the process 1000 terminates 1010.

### Publicly Communicated Indicia of Purchases Made

Another feature of some embodiments is to provide publicly communicated indicia of sales made. Indicia may be one or more of visual indicia, audible indicia, or haptic indicia, and they may be communicated through the multi-channel chat feature or they may be communicated through a separate service overlaying the chat feature. For example, when a buyer-user makes a purchase one or more of the following indicia may be provided. The platform may generate a text chat message appearing in the multi-channel chat feed stating that a particular use has made a purchase. The platform may cause an animation or icon to be displayed through each user's GUI, indicating that a purchase has been made, and may associate the indicia with the purchaser. The platform may cause a tone or audio file to be played through each user's local device interface indicating that a purchase has been made. According to one embodiment, an example of providing publicly communicated indicia of sales made may take the following form. During a live steaming ecommerce event, a seller may be pitching a given product for sale while the store demonstrates the product in side-by-side video streams. A multichannel chat feature may be displayed below the video streams, where audience members are commenting on the product. A particular user, e.g. Betty, may indicate in the chat that she purchased the product before and now recommends it to other viewers. In response to Betty's comment and the ongoing video streams, a second user, e.g. Tom, may execute a purchase transaction. In response to the completed purchase, the platform may automatically generate a text chat message in real time congratulating Tom on his purchase. The chat message may coincide with a simultaneously played, platform-generated, tone or sound file, like a ringing cash register. The platform may further cause an animation of a dollar sign to float over the chat feature and then dissipate after a predetermined time.

### Dynamic Pick List

A further feature of some embodiments relates to order fulfillment. More specifically, it relates to improved methods of picking items from stockroom shelves by warehouse staff. Upon completion of a purchase transaction, the customer's order may be compiled into a list of items and automatically communicated by the platform to warehouse staff in the form of an interactive list, which may be displayed on a mobile device such as a tablet computer. A staff member carries the interactive list from shelf-to-shelf while picking items from the interactive list. When an item is removed from the shelf, the staff member finds the item in the interactive list and clicks or taps it, which communicates to the platform that the item has been picked. Some embodiments may further allow for partially filling an order. For instance, certain items may be temporarily unavailable. Rather than delay the order, the available items may be shipped and the remaining items may remain in an open order for later fulfillment.

### Rapid Inventory Update

Another feature of some embodiments of the platform include means for rapidly uploading product data into an inventory system. An example of such a feature includes a handheld device adapted to scan UPC codes or similar optical product codes. The handheld device communicates a code read from a product to server that retrieves product information associated with the code. Typically, the information identifies the product and may include product photos provided by the manufacturer, product descriptions, feature lists, and so on. One or more elements of the associated product information may be transmitted back to the handheld device, and used to populate an inventory input screen. A user may include additional information such as the quantity being added to inventory, and the aisle, shelf, and bin number where the product is located. In some embodiments location data such as aisle, shelf and bin number may be read into the system automatically with an optical code pre-positioned on the bin where the new inventory is deposited.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I claim:

1. A computer-implemented method (100) of affiliating computer accounts for live e-commerce video streaming, comprising the steps of:
providing at least one store account listing at least one product for sale, each of the at least one store account being identified by a unique store code;
providing at least one seller account having a plurality of social media followers, each of the at least one seller account being identified by a unique seller code;
providing a graphical user interface comprising:
a plurality of selectable enumerations including a selectable enumeration of stores and a selectable enumeration of sellers;
the enumeration of stores comprising a list of store elements, each store element of the list specifying predetermined features including a store name, at least one product for sale, the store code, and an Add Store control;
the enumeration of sellers comprising a list of seller elements, each seller element of the list specifying predetermined features including a seller name, a number of social media followers, the seller code, and an Add Seller control;
a user of the store account selecting a seller element of the enumeration of sellers, or a user of the seller account selecting a store element of the enumeration of stores;
the user of the store account actuating the Add Seller control of the seller enumeration of sellers causing the platform to create an affiliate table containing the store code of the store account and the seller code of the seller account, and set a status of the affiliation table to pending, or the user of the seller account actuating the Add Store control of the enumeration of stores causing the platform to create the affiliate table containing the store code of the store account and the seller code of the seller account, and set the status of the affiliate table to pending;
visually changing the Add Seller control, indicating that the status of the affiliate table is pending, and sending a notification to the seller account indicating the store account through which the Add Seller control was actuated, the notification including an interactive invitation to affiliate the seller account with the store account, or visually changing the Add Store control to indicate that the status of the affiliate table is pending and sending a notification to the store account indicating the seller account through which the Add Store control was actuated, the notification including an interactive invitation to affiliate with the seller account; and
the user of the store account interacting with the interactive invitation to affiliate, wherein the interaction causes the platform to update the status of the affiliate table to established, or the user of the seller account interacting with the interactive invitation to affiliate, wherein the interaction causes the platform to update the status of the affiliate table to established.

2. The computer-implemented method of claim 1, wherein affiliating computer accounts for live e-commerce video streaming further comprises the steps of:
recording a seller code record in a store affiliate table having a store affiliate primary key, a store code record, and a commission rate record, wherein the store affiliate primary key is recorded in an affiliate commission table, a store collection table, a show table, and wherein a primary key of the store collection table and a primary key of the show table are recorded in a shop payments table along with a transaction amount.

3. The computer-implemented method of claim 2, further comprising the step of recording a list of product indicium records and the commission rate record in the show table.

4. The computer-implemented method of claim 3, further comprising the step of recording the list of product indicium records and the commission rate record in the store collection table.

5. The computer-implemented method of claim 1, wherein the plurality of selectable enumerations comprises tabs.

6. The computer-implemented method of claim 1, wherein the plurality of selectable enumerations of seller elements further comprises at least one indicium of experience as a seller.

7. The computer-implemented method of claim 1, wherein the at least one indicium of experience as a seller is selected from one or more of a number of live-stream shows completed, a number of products sold, and enumeration of product types sold, or a narrative.

8. The computer-implemented method of claim 1, wherein the act of recording the seller indicium record and the store indicium record in the affiliate table triggers a state change of the computer-implemented method characterized by a set of permissions including a permission allowing a user of the seller account to live stream an ecommerce event featuring the one or more products for sale of the store account, wherein a user of the seller account causes a sale of the one or more products for sale for which the seller account is credited with a commission according to the commission rate.

9. A computer readable medium storing non-transitory computer executable instructions that, when executed, cause a computer system to execute the steps of:
providing at least one store account listing at least one product for sale, each of the at least one store account being identified by a unique store code;
providing at least one seller account having a plurality of social media followers, each of the at least one seller account being identified by a unique seller code;
providing a graphical user interface comprising:
a plurality of selectable enumerations including a selectable enumeration of stores and a selectable enumeration of sellers;
the enumeration of stores comprising a list of store elements, each store element of the list specifying predetermined features including a store name, at least one product for sale, the store code, and an Add Store control;
the enumeration of sellers comprising a list of seller elements, each seller element of the list specifying predetermined features including a seller name, a number of social media followers, the seller code, and an Add Seller control;
a user of the store account selecting a seller element of the enumeration of sellers, or a user of the seller account selecting a store element of the enumeration of stores;
the user of the store account actuating the Add Seller control of the enumeration of sellers causing the platform to create an affiliate table containing the store code of the store account and the seller code of the seller account, and set a status of the affiliation table to pending, or the user of the seller account actuating the Add Store control of the enumeration of stores causing the platform to create the affiliate table containing the store code of the store account and the seller code of the seller account, and set the status of the affiliate table to pending;
visually changing the Add Seller control, indicating that the status of the affiliate table is pending, and sending a notification to the seller account indicating the store account through which the Add Seller control was actuated, the notification including an interactive invitation to affiliate the seller account with the store account, or visually changing the Add Store control to indicate that the status of the affiliate table is pending and sending a notification to the store account indicating the seller account through which the Add Store control was actuated, the notification including an interactive invitation to affiliate with the seller account; and
the user of the store account interacting with the interactive invitation to affiliate, wherein the interaction causes the platform to update the status of the affiliate table to established, or the user of the seller account interacting with the interactive invitation to affiliate, wherein the interaction causes the platform to update the status of the affiliate table to established.

10. The computer readable medium of claim 9, wherein affiliating computer accounts for live e-commerce video streaming further comprises the steps of:
recording a seller code record in a store affiliate table having a store affiliate primary key, a store code record, and a commission rate record, wherein the store affiliate primary key is recorded in an affiliate commission table, a store collection table, a show table, and wherein a primary key of the store collection table and a primary key of the show table are recorded in a shop payments table along with a transaction amount.

11. The computer readable medium of claim 10, further comprising the step of recording a list of product indicium records and the commission rate record in the show table.

12. The computer readable medium of claim 11, further comprising the step of recording the list of product indicium records and the commission rate record in the store collection table.

13. The computer readable medium of claim 9, wherein the plurality of selectable enumerations comprises tabs.

14. The computer readable medium of claim 9, wherein the plurality of selectable enumerations of seller elements further comprises at least one indicium of experience as a seller.

15. The computer readable medium of claim 9, wherein the at least one indicium of experience as a seller is selected from one or more of a number of live-stream shows completed, a number of products sold, and enumeration of product types sold, or a narrative.

16. The computer readable medium of claim 9, wherein the act of recording the seller indicium record and the store indicium record in the affiliate table triggers a state change of the computer-implemented method characterized by a set of permissions including a permission allowing a user of the seller account to live stream an ecommerce event featuring the one or more products for sale of the store account, wherein a user of the seller account causes a sale of the one or more products for sale for which the seller account is credited with a commission according to the commission rate.

17. A computer system comprising one or more processors, a display, a camera, and one or more memories storing non-transitory computer executable instructions that, when executed by the one or more processors, cause the computer system to execute the steps of:
providing at least one store account listing at least one product for sale, each of the at least one store account being identified by a unique store code;
providing at least one seller account having a plurality of social media followers, each of the at least one seller account being identified by a unique seller code;
providing a graphical user interface comprising:
a plurality of selectable enumerations including a selectable enumeration of stores and a selectable enumeration of sellers;
the enumeration of stores comprising a list of store elements, each store element of the list specifying predetermined features including a store name, at least one product for sale the store code, and an Add Store control;
the enumeration of sellers comprising a list of seller elements, each seller element of the list specifying predetermined features including a seller name, a number of social media followers, the store code, and an Add Seller control;
a user of the store account selecting a seller element of the enumeration of sellers, or a user of the seller account selecting a store element of the enumeration of stores;
the user of the store account actuating the Add Seller control of the seller account causing the platform to create an affiliate table containing the store code of the store account and the seller code of the seller account, and set a status of the affiliation table to pending, or the user of the seller account actuating the Add Store control of the store account causing the platform to create the affiliate table containing the store code of the store account and the seller code of the seller account, and set the status of the affiliate table to pending;
visually changing the Add Seller control, indicating that the status of the affiliate table is pending, and sending a notification to the seller account indicating the store account through which the Add Seller control was actuated, the notification including an interactive invitation to affiliate the seller account with the store account, or visually changing the Add Store control to indicate that the status of the affiliate table is pending and sending a notification to the store account indicating the seller account through which the Add Store control was actuated, the notification including an interactive invitation to affiliate with the seller account; and
the user of the store account interacting with the interactive invitation to affiliate, wherein the interaction causes the platform to update the status of the affiliate table to established, or the user of the seller account interacting with the interactive invitation to affiliate, wherein the interaction causes the platform to update the status of the affiliate table to established.

18. The computer system of claim 17, wherein affiliating computer accounts for live e-commerce video streaming further comprises the steps of:
recording a seller code record in a store affiliate table having a store affiliate primary key, a store code record, and a commission rate record, wherein the store affiliate primary key is recorded in an affiliate commission table, a store collection table, a show table, and wherein a primary key of the store collection table and a primary key of the show table are recorded in a shop payments table along with a transaction amount.

19. The computer system of claim 18, further comprising the step of recording a list of product indicium records and the commission rate record in the show table.

20. The computer system of claim 19, further comprising the step of recording the list of product indicium records and the commission rate record in the store collection table.

21. The computer system of claim 17, wherein the plurality of selectable enumerations comprise tabs.

22. The computer system of claim 17, wherein the plurality of selectable enumerations of seller elements further comprises at least one indicium of experience as a seller.

23. The computer system of claim 17, wherein the at least one indicium of experience as a seller is selected from one or more of a number of live-stream shows completed, a number of products sold, and enumeration of product types sold, or a narrative.

24. The computer system of claim 17, wherein the act of recording the seller indicium record and the store indicium record in the affiliate table triggers a state change of the computer-implemented method characterized by a set of permissions including a permission allowing a user of the seller account to live stream an ecommerce event featuring the one or more products for sale of the store account, wherein a user of the seller account causes a sale of the one or more products for sale for which the seller account is credited with a commission according to the commission rate.

25. A graphical user interface comprising:
a plurality of selectable enumerations including a selectable enumeration of store accounts, each store account being uniquely identified by a store code, and a selectable enumeration of seller accounts, each seller account being uniquely identified by a seller code;
the enumeration of stores comprising a list of store elements, each store element of the list specifying predetermined features including a store name, at least one product for sale, a commission rate, the store code, and an Add Store control;
the enumeration of sellers comprising a list of seller elements, each seller element of the list specifying predetermined features including a seller name, a number of social media followers, the store code, and an Add Seller control;
the Add Seller control of the seller account being configured to cause, upon actuations by a store-user, the platform to create an affiliate table containing the store code of the store account and the seller code of the seller account, and set a status of the affiliation table to pending,
the Add Store control of the store account being configured to cause, upon actuation a seller-user, the platform to create the affiliate table containing the store code of the store account and the seller code of the seller account, and set the status of the affiliate table to pending;
the Add Seller control being configurable, upon actuation by the store-user, to visually indicate that the status of the affiliate table is pending, and sending a notification to the seller account indicating the store account through which the Add Seller control was actuated, the notification including an interactive invitation to affiliate the seller account with the store account; and
the Add Store control being configurable, upon actuation by the seller-user, to indicate that the status of the affiliate table is pending, and sending a notification to the store account indicating the seller account through which the Add Store control was actuated, the notification including an interactive invitation to affiliate with the seller account.

26. The graphical user interface of claim 25, wherein the plurality of selectable enumerations comprise tabs.
